(19) United States
(12) Patent Application Publication
(10) Pub. No.: US 2008/0123821 A1
(43) Pub. Date: May 29, 2008

(54) Barge-in capability for emergency call returns

(76) Inventors: Stuart Owen Goldman, Scottsdale, AZ (US); Richard E. Krock, Naperville, IL (US); Karl F. Rauscher, Emmaus, PA (US); James Philip Runyon, Wheaton, IL (US)

Correspondence Address: Lucent Technologies Inc.;Docket Administrator - Room 2F-190, 600 Mountain Ave., P.O. Box 636, Murray Hill, NJ, 07974-0636, US

(21) Appl. No.: 11/605,909

(22) Filed: Nov. 29, 2006

(51) Int. Cl. H04M 11/04

(52) U.S. Cl. 379/45

(57) ABSTRACT

A barge-in capability for emergency call returns is disclosed. The barge-in capability allows a PSAP to connect to an original calling party in instances where the party party is engaged in another call at the time of the call return attempt. Barge-in may be implemented by setting up a 3-way conference between the PSAP, the original calling party and at least one other party associated with the other call; or alternatively, by disconnecting the at least one other party and setting up a 2-way connection between the PSAP and the original calling party.

### FIELD OF THE INVENTION

This invention relates generally to communication networks and, more particularly to systems and methods for serving emergency calls.

### BACKGROUND OF THE INVENTION

In general, it is known for communications networks, such as the Public Switched Telephone Network (PSTN) or the like, to service emergency calls, e.g., such as 9-1-1 calls or the like. Typically, such emergency calls are directed to a dispatch center comprising a Public Safety Answering Point (PSAP) or other like network facility that serves the calling party or is otherwise situated to receive the emergency call. As is well known, the PSAP includes human operators trained to take/receive such emergency calls, gather information relevant to the emergency and dispatch assistance to calling parties as may be necessary. Occasionally, however, an emergency call can be released or terminated by the calling party prematurely before the call taker is able to complete working the call. For example, an emergency call could be released prematurely due to an equipment problem or due to the calling party being under duress.

To accommodate such situations, it is known for PSAPs to return the emergency call, that is to call back the original calling party directory number, IP address or the like in attempt to reconnect to the original calling party and complete working the emergency call. However, to the extent call PSAP returns are known, they will fail (i.e., fail to connect to the original calling party) if the PSAP gets a busy signal which may occur for example, if the original calling party makes or receives another call in the interim prior to the call return attempt. Some agencies have a policy that when a call return fails, a police car may be dispatched to investigate. Generally, however, it is an inefficient use of resources to dispatch the police without knowing the full nature of the emergency, inasmuch as costs are incurred that could possibly have been avoided but for the emergency call ending prematurely. Additionally, the PSAP may periodically re-attempt the call return if a busy signal is received or other connection failure is experienced. However, the busy signal may persist for some time, possibly throughout several re-attempted call returns yielding still further inefficiencies. Accordingly, a need exists to accommodate emergency call returns in a manner that allows for connecting the PSAP to the original calling party even when encountering a busy signal.

### SUMMARY OF THE INVENTION

This need is addressed and a technical advance is achieved in the art by providing a barge-in capability for emergency call returns. The barge-in capability allows a PSAP to connect to an original calling party in instances where the party has made or received another call in the interim prior to the call return attempt.

In one embodiment, there is provided a method exercisable in a communication system having connected an original calling party to a Public Safety Answering Point (PSAP) coincident to an emergency call, and wherein the emergency call is terminated prematurely, to reconnect the PSAP to the original calling party. The method comprises receiving a call return request initiated by the PSAP, the call return request including a PSAP indicator so as to identify the call return request as having a high priority. Coincident to receiving the call return request, the original calling party is detected to be engaged in another call with at least one other party. Nevertheless, based on the priority of the call return request, the PSAP is reconnected to the original calling party even though the original calling party is engaged in another call. In one embodiment, the step of reconnecting the PSAP to the original calling party comprises setting up a 3-way conference between the PSAP, the original calling party and the at least one other party. Alternatively, the step of reconnecting the PSAP to the original calling party comprises disconnecting the at least one other party and setting up a 2-way connection between the PSAP and the original calling party.

In another embodiment, there is provided a communication system including a PSAP adapted for serving emergency calls. The PSAP is operable to receive an emergency call from an original calling party and, if the emergency call is terminated prematurely, to initiate a call return to the original calling party. The communication system further includes a terminating node operable to receive the call return and to reconnect the PSAP to the original calling party. The terminating node comprises an originating node relative to the original emergency call but defines a terminating node for the call return. The terminating node is operable to reconnect the PSAP to the original calling party even though the original calling party is engaged in another call with at least one other party. In one embodiment, the terminating node reconnects the PSAP to the original calling party by setting up a 3-way conference between the PSAP, the original calling party and the at least one other party. Alternatively, the terminating node operates to reconnect the PSAP to the original calling party by disconnecting the at least one other party and setting up a 2-way connection between the PSAP and the original calling party.

In yet another embodiment, there is provided an article comprising one or more computer-readable signal-bearing media; and means in the one or more media, responsive to receiving a call return request from a Public Service Answering Point (PSAP), to reconnect the PSAP to an original calling party having initiated an emergency call. The reconnect means is operable to reconnect the PSAP to the original calling party even though the original calling party is engaged in another call with at least one other party. The reconnect means is operable to reconnect the PSAP to the original calling party by setting up a 3-way conference between the PSAP, the original calling party and the at least one other party; or alternatively, by disconnecting the at least one other party and setting up a 2-way connection between the PSAP and the original calling party.

### BRIEF DESCRIPTION OF THE DRAWINGS

The foregoing and other advantages of the invention will become apparent upon reading the following detailed description and upon reference to the drawings in which:

FIG. 1 is a block diagram of an exemplary communication network operable to provide barge-in capability for emergency call returns according to embodiments of the present invention;

FIG. 2 is a flowchart showing steps for providing barge-in capability for emergency call returns according to embodiments of the present invention; and

FIG. 3 is a message sequence chart associated with providing barge-in capability for emergency call returns according to embodiments of the present invention.

### DESCRIPTION OF THE PREFERRED EMBODIMENT(S)

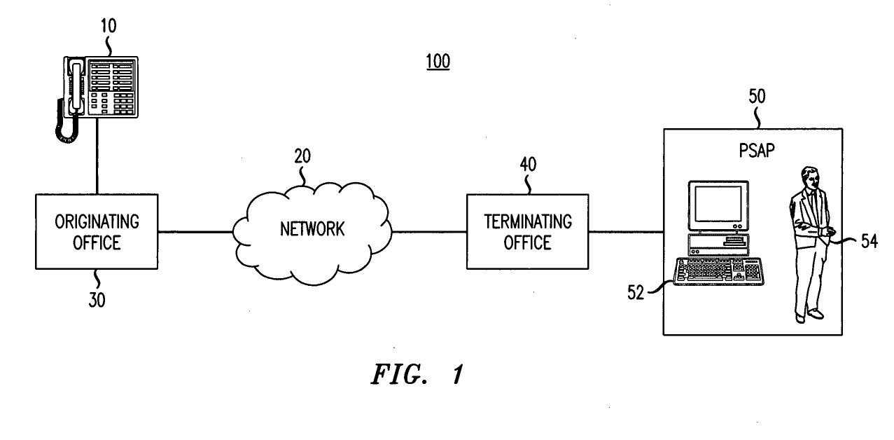

FIGS. 1-3 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 operable to provide barge-in capability for emergency call returns according to embodiments of the present invention. With reference to FIG. 1, a calling party uses an end user terminal or end instrument 10 to place an emergency call (e.g., by dialing “911”). The user terminal 10 may comprise generally any device having capacity to make and receive calls comprising, for example and without limitation, a mobile phone, wireline phone, a PDA, VoIP phone or SIP phone, laptop or desktop computer.

Responsive to the emergency call, communication network 100 is adapted to link the calling party to a Public Safety Answering Point (PSAP) 50 or other like network facility that is adapted to serve emergency calls. To that end, the user terminal and PSAP 10, 50 are logically connected to a network 20 (e.g., the PSTN or an IP network) via facilities 30, 40 comprising, e.g., exchanges, end offices or switches that are operable to process and switch calls, including emergency calls, via the communication network 20. Conventionally, and as shown, the facility 30 serving the terminal 10 having originated the call is referred to as the originating office (or originating switch) and the facility 40 serving the PSAP 50 is referred to as the terminating office (or terminating switch).

As will be appreciated, the communication network 100 may be implemented in one or more network topologies including, without limitation, wireless or wireline implementations, IP- or IMS-based topologies or some combination thereof. For example, in a wireline configuration, the terminal 10 is optionally a landline telephone or other like device and the originating office 30 is a central office switch such as a 5ESS® switching system or other like switch. In a wireless configuration, the terminal 10 is optionally a wireless phone and the originating office 30 is a Mobile Switching Center (MSC) such as an AUTOPLEX™ switching system or other like system. In an IMS network, the terminal 10 is optionally a landline or mobile phone and the originating office 30 is a Call Session Control Function (CSCF) such as may reside in a Softswitch or Media Gateway. The terminating office 40 and PSAP 50 may similarly be implemented in wireless, wireline, IP or IMS-based configurations.

In a suitable embodiment, the originating and terminating offices 30, 40 and/or the applicable switching or other equipment contained therein is provisioned with an emergency call service or feature. Accordingly, when the terminal 10 is used to place an emergency call (e.g., by dialing 9-1-1 in the United States of America or another emergency telephone number or code as may be the case in other countries), the originating office 30 serving the terminal 10 recognizes the call as an emergency call, and routes the call over the network 20 to a designated PSAP 50, e.g., one serving the geographic area in which the terminal 10 is located. Upon receiving the call, the PSAP 50 suitably routes and/or otherwise connects the call to a workstation 52 of an available PSAP operator or call taker 54. For simplicity and clarity herein, only one PSAP and one workstation are shown. However, it is to be appreciated that a single PSAP is suitably provisioned with a plurality of workstations in the usual manner and that a plurality of PSAPs are similarly equipped and/or likewise arranged with respect to the network 20.

Presuming the emergency call is ultimately answered by the PSAP 50, then in the usual manner a signal, message or other appropriate indication of the same is returned to the originating office 30. The originating office 30 completes the call set-up in a conventional manner so that the emergency call is connected through the network 20 to the PSAP 50 and accordingly, the call taker 54 can communicate with the caller to begin serving the emergency call. However, some time during the call, presume for purposes of example that the emergency call is released or terminated by the calling party prematurely before the call taker is able to complete working the call.

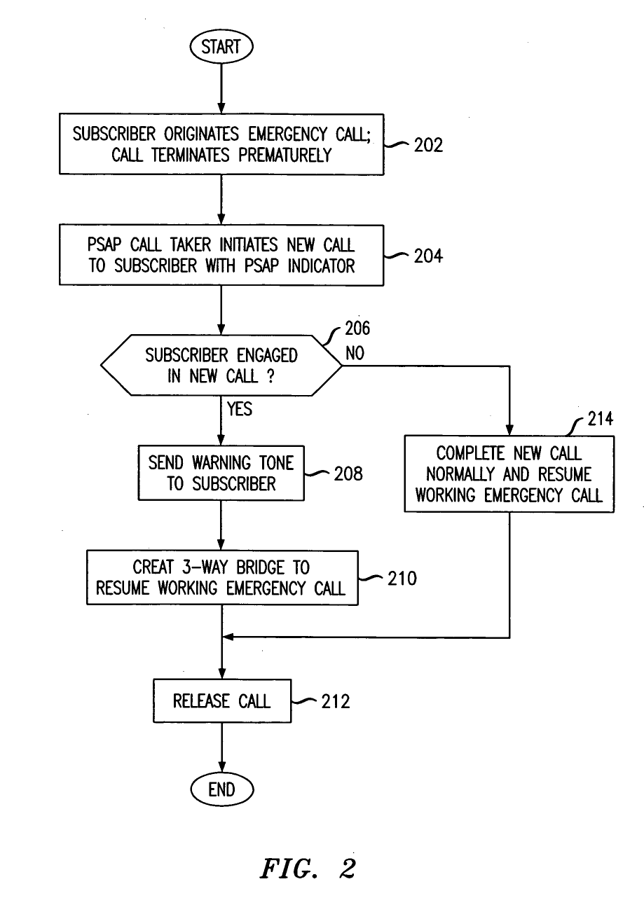

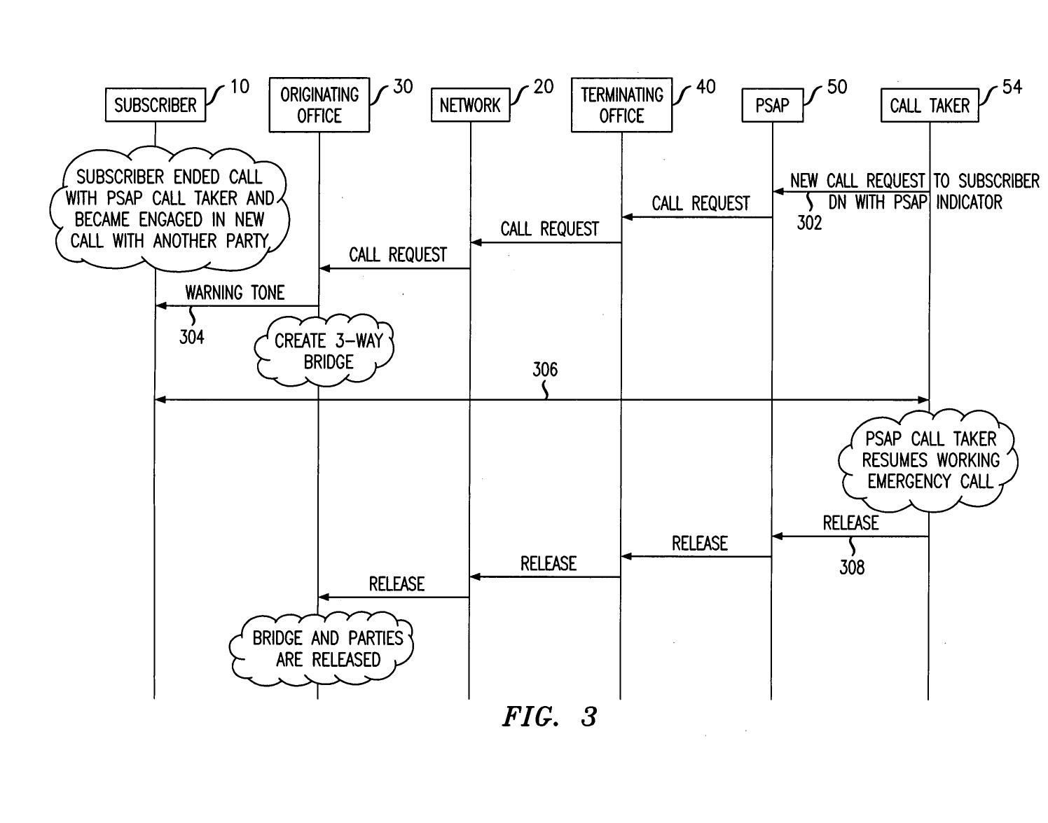

Most typically, the call taker will attempt to return the emergency call, that is to call back the original calling party directory number, IP address or the like in attempt to reconnect to the original calling party and complete working the emergency call. Note that in the case of a call return from the PSAP 50 to the user terminal 10, the originating and terminating offices are reversed, i.e., facility 40 becomes the originating office and facility 30 becomes the terminating office. Heretofore, such call returns would fail if the original calling party were engaged in another call at the time of the call return. The originating office 40 would receive a “busy” signal indicating that the original calling party is unavailable to receive the reconnect attempt. According to the prior art, therefore, the PSAP 50 will have been unable to reconnect to the original called party until such time as the original calling party ends the second call. However, as will be described in greater detail in relation to FIG. 2 and FIG. 3, embodiments of the present invention allow for the PSAP to successfully reconnect to the original calling party even when encountering a busy signal.

Turning to FIG. 2, there is shown a flowchart that may be implemented in a communication system of the type shown in FIG. 1 to provide a PSAP barge-in capability for emergency call returns. In one embodiment, the steps of FIG. 2 are implemented using stored software routines within the originating or terminating offices 30, 40 of the communication network 100. The steps of FIG. 2 may be implemented on any computer-readable signal-bearing media residing within the originating or terminating offices 30, 40 or ancillary platforms (not shown) of communication network 100. As will be appreciated, however, the method is not limited to the network or elements of FIG. 1. The computer-readable signal-bearing media may comprise, for example and without limitation, floppy disks, magnetic tapes, CD-ROMs, DVD-ROMs, hard disk drives or electronic memory. The computer-readable signal-bearing media store software, firmware and/or assembly language for performing one or more functions relating to FIG. 2.

FIG. 3 shows a message sequence corresponding to the method of FIG. 2. Where applicable, the method of FIG. 2 will be described with reference to FIG. 3. For convenience and to enhance clarity of the description, the message sequence of FIG. 3 is expressed in generic terms so as to encompass a generic message flow. However, as will be appreciated, the message sequence of FIG. 3 may be implemented in any of several message formats including, without limitation, SS7 messages or SIP messages corresponding to the network topology of the communication system 100.

The method presumes at step 202, that a caller/subscriber operating user terminal 10 initiates an emergency call by dialing a suitable emergency number (e.g., “911” in the United States or Canada) and the call is received at the PSAP 50 but the call terminates prematurely.

At step 204, the PSAP call taker 54 initiates a new call request (a.k.a., call return) to the subscriber. The call return message 302 includes a PSAP indicator comprising, for example and without limitation, an identification number, label or other suitable identifier that uniquely identifies the PSAP 50 as the source of the call return or that identifies the call return as a high priority call. For example and without limitation, the PSAP indicator and priority may be indicated in a CPC value of an SS7 IAM (Initial Address Message) or may be indicated in a Resource Priority Header of a SIP Invite Message, indicating an emergency call. Alternatively or additionally, the PSAP indicator may further indicate the call taker 52 and/or terminal 52 that initiated the call return. The call return message 302 is propagated from the PSAP 50 to the originating office 30 of the original call (in this case a terminating office) via PSAP 50, office 40 (in this case an originating office) and network 20. For convenience, the term “originating office” will be understood in FIG. 2 and FIG. 3 to refer to the originating office 30 of the original call, unless stated otherwise.

At step 206, the originating office 30 determines whether the subscriber is engaged in a new call with a new party. This may occur, for example, if the subscriber had either initiated or received a new call with the new party prior to the PSAP call return 302. If the subscriber is determined to be engaged in a new call, the subscriber would normally be unavailable to receive the call return 302 from the PSAP. According to embodiments of the present invention, however, the originating office recognizes based on the PSAP indicator that the call return 302 is an emergency call return having been originated from the PSAP 50. In such case, the originating office 30 initiates a barge-in sequence to allow the PSAP 50 to reconnect to the subscriber and to continue working the emergency call.

In one embodiment, the originating office initiates a barge-in sequence at step 208 by issuing a warning tone 304 to the user terminal 10. Alternatively or additionally, the originating office may issue a voice message, text display or other suitable message to inform the subscriber that the PSAP 50 will be barging in to the existing call. Then, at step 210, the originating office connects the PSAP 50 to the existing call by creating a 3-way bridge, thereby enabling the PSAP call taker 54 to participate in the call while maintaining the connection between the subscriber and the second party. Optionally, the originating office may terminate or preempt the existing call connection to the second party so as to yield a 2-way connection between the PSAP call taker 54 and the subscriber. However, it is contemplated that the existing call between the subscriber and the second party might be related to the emergency and thus it would normally be preferable to force a 3-way conference rather than pre-empt the connection to the second party.

Advantageously, embodiments of the invention permit the 3-way conference to be established independent of the subscriber having to select a conference feature or taking any action other than to respond to the PSAP call taker 54. Also, in one embodiment, even if the subscriber is already in a conference call, the 3-way conference can be established with the original caller, the PSAP call taker and the conference circuit (physical or virtual) so that all conferenced parties can remain connected when adding the PSAP call taker. Advantageously, the new conference is established at the subscriber's node but is controlled by the PSAP (or PSAP call taker) as the initiator.

If at step 206, the originating office 30 determines that the subscriber is not engaged in a new call with a new party, the originating office completes the call return normally (i.e., without requiring barge-in) at step 214 and the PSAP call taker 54 can resume working the emergency call.

Sometime later, after the call return is completed and the PSAP call taker has completed working the call, the call connections are released. In the case that a PSAP barge-in was accomplished to create a 3-way bridge, the bridge is released at step 212. A release message 308 is propagated from the PSAP 50 to the originating office 30 via PSAP 50, office 40 and network 20.

The specific exemplary embodiments of the present invention have been described with some aspects simplified or omitted. Those skilled in the art will appreciate variations from these embodiments that fall within the scope of the invention. The described embodiments are to be considered in all respects only as illustrative and not restrictive. The invention may be deployed in legacy telephony networks as well as next-generation networks carrying voice, video and/or data. It may be deployed in virtually any communication topology used for emergency calls to a PSAP including, but not limited to wireline SS7, wireless, IP and IMS networks. The scope of the invention is, therefore, indicated by the appended claims rather than by the foregoing description. All changes that come within the meaning and range of equivalency of the claims are to be embraced within their scope.

What is claimed is:

1. In a communication system having connected an original calling party to a Public Safety Answering Point (PSAP) coincident to an emergency call, and wherein the emergency call is terminated prematurely, a method of reconnecting the PSAP to the original calling party, comprising:
receiving a call return request initiated by the PSAP, the call return request including a PSAP indicator so as to identify the call return request as having a high priority;
coincident to receiving the call return request, detecting that the original calling party is engaged in another call with at least one other party; and
based on the priority of the call return request, reconnecting the PSAP to the original calling party even though the original calling party is engaged in another call.

2. The method of claim 1, wherein the PSAP indicator uniquely identifies the PSAP as the source of the call return.

3. The method of claim 1, wherein the communication system comprises a wireline SS7 network, the call return request comprising an SS7 Initial Address Message (IAM).

4. The method of claim 1, wherein the communication system comprises an IMS network, the call return request comprising a SIP Invite Message.

5. The method of claim 1, wherein the step of reconnecting the PSAP to the original calling party comprises setting up a 3-way conference between the PSAP, the original calling party and the at least one other party.

6. The method of claim 1, wherein the step of reconnecting the PSAP to the original calling party comprises disconnecting the at least one other party and setting up a 2-way connection between the PSAP and the original calling party.

7. A communication system comprising:
a Public Safety Answering Point (PSAP) adapted for serving emergency calls, the PSAP operable to receive an emergency call from an original calling party and, if the emergency call is terminated prematurely, to initiate a call return to the original calling party;
a terminating node operable to receive the call return and to reconnect the PSAP to the original calling party, the terminating node operable to reconnect the PSAP to the original calling party even though the original calling party is engaged in another call with at least one other party.

8. The communication system of claim 7, wherein the terminating node is operable to reconnect the PSAP to the original calling party by setting up a 3-way conference between the PSAP, the original calling party and the at least one other party.

9. The communication system of claim 7, wherein the terminating node is operable to reconnect the PSAP to the original calling party by disconnecting the at least one other party and setting up a 2-way connection between the PSAP and the original calling party.

10. The communication system of claim 7, wherein the terminating node comprises an originating node of the communication system relative to the original emergency call, the originating node defining a terminating node relative to the call return.

11. An article comprising:
one or more computer-readable signal-bearing media; and
means in the one or more media, responsive to receiving a call return request from a Public Service Answering Point (PSAP), to reconnect the PSAP to an original calling party having initiated an emergency call, the reconnect means operable to reconnect the PSAP to the original calling party even though the original calling party is engaged in another call with at least one other party.

12. The article of claim 11, wherein the reconnect means is operable to reconnect the PSAP to the original calling party by setting up a 3-way conference between the PSAP, the original calling party and the at least one other party.

13. The article of claim 11, wherein the reconnect means is operable to reconnect the PSAP to the original calling party by disconnecting the at least one other party and setting up a 2-way connection between the PSAP and the original calling party.
